(19) United States
(12) Patent Application Publication
(10) Pub. No.: US 2012/0098153 A1
(43) Pub. Date: Apr. 26, 2012

(54) PLANT AND METHOD FOR THE CONTINUOUS PRODUCTION OF PREFORMS

(75) Inventor: Jochen FORSTHOVEL, Regensburg (DE)

(73) Assignee: KRONES AG, Neutraubling (DE)

(21) Appl. No.: 13/278,373

(22) Filed: Oct. 21, 2011

(30) Foreign Application Priority Data
Oct. 26, 2010 (DE) 10 2010 042 958.9

(51) Int. Cl. B29C 45/76; B29C 45/03

(52) U.S. Cl. 264/40.1; 425/169

(57) ABSTRACT

A plant for the continuous production of preforms for plastic containers using at least polyester recyclate for the filling of foodstuffs, having at least one melt-producing upstream plant section, at least one preform producing injection molding plant section, and a plant control system, where at least the melt-producing upstream plant section and the injection molding plant section are interlocked at an interface to form a plant block. For the derivation of process alteration strategies and/or preform qualifying strategies, an inline measurement station including an evaluating device is provided at the interface for at least one quality parameter of the melt measured in the process flow.

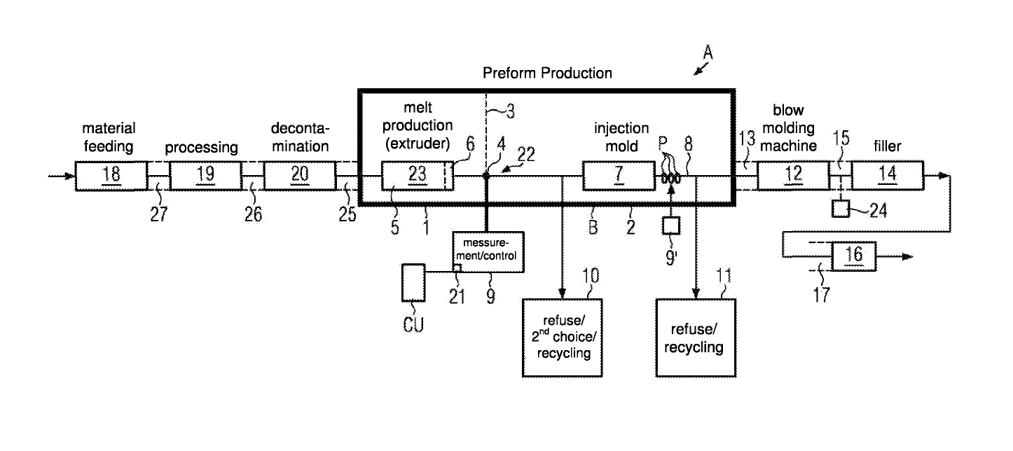

### CROSS-REFERENCE TO RELATED APPLICATION

The present application claims the benefit of priority of German Application No. 102010042958.9, filed Oct. 26, 2010. The entire text of the priority application is incorporated herein by reference in its entirety.

### FIELD OF THE DISCLOSURE

The disclosure relates to a plant and to a method for the continuous production of performs, such as used for beverage containers.

### BACKGROUND

If the process flow after the melt formation is interrupted for measuring and evaluating quality parameters of the melt, heat present from the recycling process is wasted and greater logistical efforts are necessary. If the acetaldehyde content in the melt is too high, which may be caused by too strong a shear and too high a temperature during the recycling process, foodstuffs which are neutral in terms of taste, e.g. still water, may be affected in terms of taste if these foodstuffs are filled into the plastic containers obtained from the preforms. As the quality of the plastic material introduced into the recycling process batchwise, especially PET flakes, is subject to natural fluctuations, the process flow needs controlling until the melt is discharged in order to comply with a predetermined quality standard for the melt. To this end, it is common practice to take samples of the melt or recyclate and test them in laboratory tests, for example, in order to obtain for the controlling of the process flow measurement results about the acetaldehyde content and/or the intrinsic viscosity and/or the color and/or the content of other contaminants of the melt or recyclate. Such a plant for producing the melt using a recyclate is disclosed, for example, in DE 10 2005 013 701 A1. An intermediate step that needs to be interrupted for measuring and evaluating quality parameters of the melt is an acute weak point in the process flow, which the manufacturer of the plant, who has designed the plant in such a way that the subsequent filling with foodstuffs is performed under the specific quality standards for the respective foodstuff, is unable to influence. For example, during the usual procedure involving sampling, measuring the sample and evaluating the measurement results, evaluation results that are outside a predefined tolerance range are used as an opportunity to correctively vary the upstream process flow, if necessary, to discard melt still being produced or discard preforms made from melt still being produced or identify them as B-list quality and use them for less delicate foodstuffs or other purposes, or to inspect and control in principle produced plastic containers prior to filling them in order to preclude non-permissible combinations of poor quality plastic containers with certain foodstuffs. The logistical effort for this is high. Interruptions associated therewith are cost-intensive. Inter alia for these reasons it is the aim at least of the manufacturer of the plant to interlock plant sections so as to eliminate error sources caused by a separation, which had been impossible so far, however, because interlocking

disallows the control of inevitable quality parameter fluctuations in default of access possibilities.

Document DE 10 2010 002 054.0, which has an earlier priority, already proposes a method and a plant for producing container preforms, in which, in a plant, a recycling machine is connected to a preform machine directly or via at least one intermediate storage in such a way that at least a major portion of heat introduced from a thermal treatment of the plastic material in the recycling machine can be transferred with the plastic material into the preform machine. The measurement of quality parameters of the produced plastic material and/or the control of the process flow based on quality parameters are not being dealt with.

### SUMMARY OF THE DISCLOSURE

The disclosure is based on one aspect to provide a plant and a method to be carried out in the plant, by means of which the heat from the recycling process can be utilized in an improved manner, along with reduced logistical efforts, whilst unavoidable excessive fluctuations of quality parameters of the melt are controllable without difficulties to the extent that the quality standard for the respective foodstuff to be filled in can always be observed in plastic containers produced from the preforms.

As at least the upstream plant section, from which the plasticized melt is supplied, and the injection molding plant section, in which the preforms are produced from the melt in an uninterrupted process flow, are interlocked in the plant, the heat from the recycling process contained in the melt can be utilized for the preform production in an improved manner, by reducing the logistical effort, and the acute error source caused by a separation of the plant sections is eliminated. Thus, the manufacturer of the plant is able to influence a correct operation in the transition area between the interlocked plant sections. The inline measurement station, which includes an evaluating device and is provided at the interface, allows the permanent or an intermittent measurement and evaluation at least of a significant quality parameter of the melt during the process flow, despite the interlocking, thereby creating the prerequisite to derive process alteration strategies and/or preform qualifying strategies without having to necessarily interrupt the process flow. By means of the measurement result and the evaluation result it can be ensured despite the interlocking that the plastic container filled with a foodstuff complies with the quality standard for this foodstuff because either melt of a poor quality or preforms and containers of a poor quality can be discarded, preforms or containers of a poor quality can be identified as B-list quality and prevented from being used with specific foodstuffs, or because the operator can at least be warned or the plant can ultimately be stopped, should the derived and realized strategies not have led to success. As the inline measurement and the evaluation and monitoring of the at least one quality parameter of the melt allows to ensure, by discarding inferior melt, preforms or even containers, that the required quality standard of the plastic container for the later filling thereof with the foodstuff is complied with, there is no need to interrupt the whole process flow because it is ensured that the plastic containers matching the respective foodstuff, and no plastic containers of an inferior quality standard are being filled. The inline measurement station with the evaluating device for carrying out a measurement during the process flow results, in combination with the interlocking of the plant sections, in an easily realizable securing of the required quality standard and forms a basis for interlocking yet other plant sections, including a filler and, if necessary, even a packaging plant section, to an altogether interlocked overall complex, in which the manufacturer of the plant not only makes a problem-free handling available to the user, but can also ensure from the start the respectively required, where applicable, high quality standard of either the containers or the filled containers.

According to the method the measurement and evaluation at least of one significant quality parameter of the melt during the uninterrupted process flow allows the derivation and use of process alteration strategies and/or preform qualifying strategies without the necessity to interrupt the process and despite the interlocking of plant sections in a plant block, which prevents in principle the sampling of the melt, which section block satisfies modern requirements with respect to an optimum use of energy and quality management and affords a universal basis for the further interlocking with plant sections, which makes a complete plant suited for an automatic operating procedure with a high quality standard available to users.

In a useful embodiment of the plant the inline measurement station comprises at least one subassembly for measuring the acetaldehyde content and/or the intrinsic viscosity and/or selected contaminants and/or the color of the melt, preferably at least two subassemblies for measuring the acetaldehyde content and the intrinsic viscosity.

Moreover, in a useful embodiment, the evaluating device is connected, preferably via the plant process control system, to a process parameter controller and/or an acetaldehyde blocker or a scavenger metering device and/or a starting component mixture adjustment device and/or a preform and container discarding device and/or a qualifying device. Thus, despite the interlocking, measures and strategies can be carried out during the process flow on the basis of the evaluation result, which ensure the desired quality standard of the melt and, at the same time, of the plastic containers produced from the melt later, preferably PET bottles, and allow the foodstuff, which is processed in the plant for the purpose of filling, to be filled into a plastic container having the proper quality standard.

In a useful embodiment the measurement station comprises at least one space rinsed with inert gas and permeated by the melt, and at least one gas chromatograph is arranged in at least one waste gas flow path out of the space. The gas chromatograph measures, for example, the acetaldehyde content in the waste gas flow. The rinsing with the inert gas may only be carried out for measurement purposes, but could simultaneously also be initiated for reducing at least the acetaldehyde content.

In another embodiment the intrinsic viscosity is measured as a reference standard for the molecule chain lengths in the melt by means of a melt temperature detection and a melt orifice, by means of which a pressure difference supplying a measurement result is generated directly in the melt flow or in a melt bypass flow.

In another embodiment a melt transillumination device may be provided for the color measurement, wherein preferably light transmitted by the melt is transmitted by at least one optical waveguide to the outside, where it is measured and compared with a reference.

In a useful embodiment the measurement station is located in the upstream plant section downstream of a melt filtration device. A suited place for locating the measurement station would be, for example, a shooting pot and/or a hot-runner distributor of the injection molding plant section because this is where a transition from one process step of forming the melt to another process step of producing the preform takes place and where a selective intervention is possible.

In an alternative embodiment the injection molding plant section comprises a preform aftercooling zone with cooling sleeves, and a color measurement station is arranged in the area of the aftercooling zone, preferably with a source of illumination directed to the orifice area of each preform in a cooling sleeve.

In a particularly useful embodiment the plant block made of the injection molding plant section interlocked with the upstream plant section is additionally interlocked with a container blow molding plant section, with which preferably at least one filler plant section is interlocked as well, so that the entire plant block consisting of the interlocked plant sections allows a continuous process flow until either the finished plastic containers or even the already filled plastic containers are obtained, wherein no more interruptions creating acute fault locations take place between the plant sections. This is due to the trend aimed at by the manufacturers of the plants and the users to provide complete plants with an automatic process flow and high quality. It is even possible to interlock in such a complete plant a packaging plant section with the filler plant section, e.g. by at least one capping machine, so that the user is provided with the readily packaged product on the ejection side of the overall plant block, for which product a uniform high end quality can be guaranteed owing to the interlocking and the measurement station.

Alternatively or additionally to the above solution the plant block may also comprise a decontamination plant section interlocked with the upstream plant section, an interlocked processing plant section and an interlocked material feeding plant section so as to ultimately realize an overall plant block.

According to a modification of the method practicable in the plant acetaldehyde is measured as at least one selected melt contaminant, namely by means of the acetaldehyde content of the melt and with a gas-chromatographic measurement, preferably in a rinse flow with inert gas to which the formed melt is exposed. For example, in a bottle wall of a bottle made of polyethylene terephthalate the acetaldehyde should amount to less than 2 ppm, preferably even less than 1 ppm.

According to another modification of the method the intrinsic viscosity of the melt is measured and evaluated by detecting the temperature of the melt and by pressing the melt through an orifice, by means of which a pressure difference is created which may be evaluated as being representative for the intrinsic viscosity. The intrinsic viscosity is related to the length of the molecule chain which, in turn, is significant for the strength and dimensional stability of a plastic container.

According to another modification of the method the melt is transilluminated so as to measure the color. This can be easily realized, for example, by means of photo cells with color filters.

The at least one quality parameter of the melt is measured and evaluated during the process flow either continuously, and is used for deriving strategies, or intermittently in predetermined time intervals in order to be able to detect, with a reduced measuring expenditure, yet timely, a trend of a deviation of the respective quality parameter and initiate counter-measures.

According to a useful modification of the method, for example, after the evaluation of the measurement result with a positive evaluation result, preferably if the measured result is outside a predetermined tolerance range, a plasticizing speed of an extruder is altered, and/or a cycle time in the extruder or in other process stages and/or a quantitatively controlled addition, for example, of an acetaldehyde blocker and/or scavenger are controllably altered.

According to another modification of the method, if the result of the evaluation is positive, preferably if the measured result is outside a predetermined tolerance range, preferably until the evaluation result is negative again, the melt still being produced is discarded, or the preforms produced with the melt still being produced or plastic containers blow-molded from these preforms are discarded or identified as being qualitatively inferior, and/or at least a plant operation warning is generated so as to announce the excessive fluctuation of the respective quality parameter.

Expediently, according to another modification of the method, the plant is stopped, preferably automatically by the plant process control system, if a positive evaluation result does not disappear within a predetermined time period.

According to a particularly useful modification of the method the at least one quality parameter of the melt is measured and evaluated and used for deriving strategies in a plant in which at least a container blow molding plant section is connected to the injection molding plant section, and a filler plant section is connected to the container blow molding plant section, and, preferably, even a packaging plant section is interlocked with the filler plant section, preferably by a capping machine, and/or plant sections provided upstream are interlocked with the upstream plant section, so that the user is able to carry out the method with a fully automatic process flow in one single plant block or an overall complex, while the producer of the plant had been able from the start to implement his know-how and his subject knowledge and knowledge of the method in the posterior process flow without any noteworthy danger caused by intentional or unintentional external influences.

### BRIEF DESCRIPTION OF THE DRAWING

Embodiments of the subject matter of the disclosure are explained by means of the drawing.

The FIGURE is a schematic view of a plant, with different plant configurations being outlined in this FIGURE.

### DETAILED DESCRIPTION OF THE PREFERRED EMBODIMENT

The FIGURE schematically illustrates a plant A for the continuous production of preforms P using at least polyester recyclate, typically PET flakes or chips. From the produced preforms P plastic containers, typically PET bottles, are blow-molded, which are destined for the filling of foodstuffs and are filled with a foodstuff, are sealed and packaged appropriately. The respective plastic container needs to have a specific quality standard for the respective foodstuff.

In one embodiment, the core of plant A is a plant block B, in which a melt-forming upstream plant section is permanently interlocked at 3 with a preform-producing injection molding plant section 2, with an internal interface 4 being provided between the interlocked plant sections 1, 2 at an appropriate place. The upstream plant section 1 includes at least one melt-producing extruder 23, preferably with an end-side melt filtration device 6 upstream of the interface 4. The interface 4 is arranged, for example, in the area of a shooting pot not shown in more detail and/or a hot-runner distributor of the injection molding plant section 2, upstream of injection molds of an injection molding device 7, from which the preforms P are discharged in batches or continuously and are conveyed, for example, in non-illustrated cooling sleeves along an aftercooling zone 8.

At the interface 4 there is provided at least one integrated inline measurement station 9 for at least one quality parameter of the melt. An evaluating device 21 for the result measured by the measurement station 9 belongs to the measurement station 9. The evaluating device 21 is connected, for example, to a plant process control system CU, or is integrated in the latter, by means of which the process flow in the plant is controlled.

Upstream of the plant block B (possibly integrated in the same or interlocked with the upstream plant section 1) a material feeding plant section 18 is arranged ahead of a material processing plant section 19 and a material decontamination plant section 20. Inside plant block B a refuse/recycling device 10 for rejected melt is connected between the interface 4 and the preform injection molding device 7. Moreover, a device for rejecting produced preforms P or, if possible, for the alternate usage of these second choice quality preforms or for the recycling thereof can be provided either in the aftercooling zone 8 or at the end of plant block B.

Alternatively, another measurement station, for example, for the color of the freshly produced preforms P is arranged at 9′, for example, in the aftercooling zone 8, which works with transillumination and color diodes and color filters.

In the measurement station a measurement of at least one quality parameter of the melt is carried out, e.g. of the acetaldehyde content and/or the intrinsic viscosity and/or the content of selected contaminants and/or the color (the latter alternatively or additionally to the measurement station 9′). Selected contaminants could be, for example, oligomers, limonene or the like.

The measurement of the acetaldehyde content is, for example, carried out in such a way that the measurement station comprises a space in plant block B, which is rinsed with inert gas while being penetrated by the melt. In a waste gas flow path out of this space the probe of a gas chromatograph is located, which examines the waste gas flow for certain constituents. The inert gas rinsing may further serve to reduce, inter alia, the acetaldehyde content. Another possibility would be the attachment of a so-called chemical sensor, which signalizes the presence of acetaldehyde if a chemical reaction takes place on or in the sensor.

The measurement of the intrinsic viscosity of the melt is accomplished by means of a temperature detection and by means of a pressure difference in the melt flow, which is produced by an orifice, namely either in the main melt flow or in a side flow. The color measurement of the melt is carried out, for example, by transillumination and color measurement of the transmitted light, wherein the transmitted light is transmitted further for evaluation, preferably by an optical waveguide leading out of the space of the measurement station. Usefully, at least the acetaldehyde content and the intrinsic viscosity are measured and evaluated together, as too high an intrinsic viscosity usually results in too high an acetaldehyde content.

The measurement of the at least one quality parameter of the melt produced in plant block B and processed directly in the injection molding plant section 2 is evaluated with respect to the measurement result obtained in the process flow and is compared, for example, with reference values, preferably within a tolerance range. If the evaluation result is positive, i.e. if the measured result is outside the predetermined tolerance range, process alteration strategies and/or preform and container qualifying strategies are derived so as to ensure that the required quality standard of the plastic container is guaranteed when the foodstuff is filled in later. Process alteration strategies could mean, for example, that certain process flow parameters are altered or controlled to bring the measured quality parameter back into the tolerance range, e.g. if the acetaldehyde content and/or the intrinsic viscosity is excessively increased, altering or reducing the plasticizing speed of the extruder 23 and/or the cycle time in the extruder, and/or altering the quantitatively controlled addition of acetaldehyde blockers and/or a scavenger. Moreover, a process alteration strategy would be to alter or control the mixing ratio of different used starting components, e.g. the ratio between recyclate, virgin material with a low intrinsic viscosity, virgin material with a high intrinsic viscosity, color stabilizer and the like. Furthermore, the process alteration strategy could also include the premature extraction of inferior melt or inferior preforms or plastic containers, as well as the generation of a warning message to the machine operator if predetermined thresholds are exceeded, which may eventually be performed up to the automatic emergency stop of the plant if the deterioration of the measured and evaluated quality parameter cannot be successfully overcome by means of these strategies.

As was mentioned before, the core of plant A is plant block B consisting of the two directly interlocked plant sections 1 and 2 and the measurement station 9 for at least one melt quality parameter located at the interface 4. However, expediently also the stretch blow molding machine 12, which produces the plastic containers, is interlocked with plant block B at 13, and also the filler 14 and, where appropriate, even the packaging plant section 16. The respective interlocking areas are designated with 13, 15 and 17. Alternatively or additionally, also the decontamination plant section 20 and the processing plant section 19 as well as the material feeding plant section 18 could be interlocked components of plant block B (the interlockings are shown as dashed lines at 25, 26, 27). A rejecting device 24 for already produced inferior plastic containers is provided in or at the end of the blow molding plant section 12, which containers are then recycled, where appropriate, or may be used as second choice quality for uncritical foodstuffs or other fillings.

Owing to the interlocking of at least plant sections 1, 2 the heat from the upstream process flow contained in the melt is transferred into the preform production plant section, which helps to reduce the total heat requirement and the logistical efforts. However, expediently an overall complex is created in which many of the or all plant sections are interlocked, so that no external influences or unintended manipulations, or manipulations based on a lack of process knowledge, can act on or be made between the plant sections, and that a complete plant is available to the user, providing him by means of an automatic process flow with possibly already packaged end products of high quality and a constantly high quality ready to be transported elsewhere.

1. Plant for the continuous production of preforms using at least polyester recyclate for plastic containers for the filling of foodstuffs, comprising at least one melt-producing upstream plant section, at least one preform producing injection molding plant section, and a plant process control system, at least the melt-producing upstream plant section is being interlocked with the injection molding plant section to form a plant block for the direct processing of the produced melt to preforms in the injection molding plant section, and that, for the derivation of one of process alteration strategies, preform qualifying strategies, and a combination thereof, an inline measurement station including an evaluating device is provided between the interlocked plant sections at an interface for at least one quality parameter of the melt measured during the operation of plant.

2. The plant according to claim 1, wherein the inline measurement station comprises at least one subassembly for measuring one of the acetaldehyde content, the intrinsic viscosity, the selected contaminants, the color of the produced melt, and a combination thereof.

3. The plant according to claim 1, wherein the evaluating device is connected to one of a process parameter controller, an acetaldehyde-blocker-metering device, a starting component mixture adjustment device, a preform discarding device or qualifying device, and a combination thereof.

4. The plant according to claim 1, wherein the measurement station comprises at least one space rinsed with inert gas and permeated by the melt, and that at least one gas chromatograph is arranged in a waste gas flow path out of the space.

5. The plant according to claim 2, wherein the intrinsic viscosity is measured by means of a melt temperature detection and a melt orifice.

6. The plant according to claim 2, wherein a melt transillumination device is provided for the color measurement.

7. The plant according to claim 1, wherein the upstream plant section comprises a melt filtration device at the end side, and that the measurement station is located downstream of the melt filtration device.

8. The plant according to claim 1, wherein the injection molding plant section comprises a preform aftercooling zone with cooling sleeves, and that a color measurement station is arranged in the area of the aftercooling zone.

9. The plant according to claim 1, wherein the plant block additionally comprises at least one container blow molding plant section interlocked with the injection molding plant section.

10. The plant according to claim 1, wherein the plant block comprises at least one decontamination plant section interlocked with the upstream plant section, an interlocked processing plant section and an interlocked material feeding plant section.

11. Method for the continuous production of preforms for plastic containers for the filling of foodstuffs using at least polyester recyclate in a plant having at least one melt-producing upstream plant section and at least one preform-producing injection molding plant section, comprising, for the direct processing of the produced melt in an uninterrupted process flow to obtain the preforms, interlocking the upstream plant section with the injection molding plant section, and for deriving process alteration strategies and/or preform qualifying strategies, measuring and evaluating at least one quality parameter of the melt during the process flow at an internal interface.

12. The method according to claim 11, and measuring acetaldehyde as at least one selected melt contaminant by means of the acetaldehyde content of the melt with a gas-chromatographic measurement.

13. The method according to claim 11, and measuring the intrinsic viscosity of the melt by a temperature detection and a melt orifice pressure difference.

14. The method according to claim 11, and measuring the color by transilluminating the melt.

15. The method according to claim 11, wherein the measurement and evaluation during the process flow are either continuous or intermittent.

16. The method according to claim 11, and controllably altering, after the evaluation of the measurement result with a positive evaluation result, one of a plasticizing speed of an extruder, a cycle time, a quantitatively controlled addition of an acetaldehyde blocker, a scavenger, and a combination thereof.

17. The method according to claim 11, wherein, after the evaluation of the measurement result with a positive evaluation result, one of discarding the melt still being produced discarding or identifying as being inferior preforms or containers produced with the melt still being produced, generating at least a plant operation warning, and a combination thereof.

18. The method according to claim 17, and automatically triggering an emergency stop of the plant if the evaluation result remains positive over a predetermined period.

19. The method according to claim 11, and measuring and evaluating the at least one quality parameter of the melt in a plant in which at least a container blow molding plant section and a filler plant section are, in this sequence, interlocked with one of the injection molding plant section, at least one decontamination plant section, and a combination thereof, and interlocking a processing plant section and a material feeding plant section with the upstream plant section.

20. The plant according to claim 2, and two subassemblies for the combined measurement of the acetaldehyde content and the intrinsic viscosity.

21. The plant according to claim 3, wherein the evaluating device is connected via the plant process control system.

22. The plant according to claim 6, and an optical waveguide for transmitted light guided out of the measurement station to the outside.

23. The plant according to claim 7, wherein the measurement station is located in the area of one of a shooting pot, a hot-runner distributor, and a combination thereof of the injection molding plant section.

24. The plant according to claim 8, and wherein the color measurement station is oriented to the orifice areas of each preform located in a cooling sleeve.

25. The plant according to claim 9, and further comprising at least one filler plant section interlocked with the container blow molding plant section.

26. The plant according to claim 9, and further comprising at least one packaging plant section being interlocked with the filler plant section

27. The method according to claim 12, wherein the acetaldehyde is measured in an inert gas/melt rinse flow.

28. The method according to claim 16, wherein the measurement result is outside a predetermined tolerance range.

29. The method according to claim 17, and wherein the measurement result is outside a predetermined tolerance range.

30. The method according to claim 17, and wherein the evaluation result is negative again.

31. The method according to claim 19, wherein the plant includes a packaging plant section.
